(19) United States
(12) Patent Application Publication
(10) Pub. No.: US 2003/0235215 A1
(43) Pub. Date: Dec. 25, 2003

(54) Apparatus and method for aggregation and transportation for plesiosynchronous framing oriented data formats

(76) Inventors: John Robert Carrel, Rockwall, TX (US); Samir Satish Sheth, Plano, TX (US); Steve Judge, Plano, TX (US); Brian Royal, Garland, TX (US)

Correspondence Address: George R. Schultz, Schultz & Associates, P.C., One Lincoln Centre, 5400 LBJ Freeway, Suite 525, Dallas, TX, 75240, US

(21) Appl. No.: 10/402,314

(22) Filed: Mar. 28, 2003

Related U.S. Application Data
(60) Provisional application No. 60/368,214, filed on Mar. 28, 2002.

(51) Int. Cl. H04J 3/07

(52) U.S. Cl. 370/506; 370/509

(57) ABSTRACT

The invention provides an apparatus and method for transparently transporting four plesiosynchronous OC-48 signals over a network. Multiple plesiosynchronous data streams are aggregated onto an independent clock source at an ingress circuit through the use of “stuffing” bits. The independent clock is selected such that the output data rate is greater than the composite input data rate of all the plesiosynchronous data streams. The signal is encapsulated with forward error correction at the transport interface, serialized, and modulated across the transport system. An egress circuit at the receiving end recovers the modulated signal and extracts the data stream and timing extraction resulting in a return of the original data frames with the same timing as the originals. In this manner, the timing is reproduced identical to the timing of the incident signal at the ingress path, ensuring the data is identical in content and timing.

### CROSS-REFERENCE TO RELATED APPLICATIONS

This application claims priority to Provisional Application Serial No. 60/368,214, entitled Apparatus and Method for Aggregation and Transportation of Plesio-Synchronous Framing Oriented Data Formats, by Carrel, et al. filed Mar. 28, 2002.

### FIELD OF THE INVENTION

This invention relates to a computer system that permits transportation of plesiosynchronous (nearly synchronous) data streams that conform to different protocols to be transparently multiplexed together without protocol conversion or pointer processing and transmitted over a high-speed data channel.

### BACKGROUND OF THE INVENTION

The SONET standard is the American National Standards Institute standard for synchronous data transmission on optical media. It defines data transmission in a format having “frames” of data with a beginning and end in a continuous stream. The data stream with the lowest density defined by the SONET standard is a stream of frames transmitted every 125 microseconds. Each frame includes three 9-byte columns of transport overhead and 879-byte columns of payload. This least dense SONET stream is called a Synchronous Transport Signal (STS-1). A stream of STS frames conveys interleaved columns of frames at the rate of 8000 frames/second. For example, the first nine 9-byte columns of an STS frame are transport overhead, and the remaining 261 columns are referred to as the Synchronous Payload Container. The transport overhead consists of section overhead, as defined by the SONET standard.

The first bytes of an STS-1 frame are designated as A1 and A2 bytes. These bytes are used to detect the beginning of frames, which permits SONET devices to recognize SONET frames.

The speed of data transmission over optical networks has increased drastically in recent years. Consequently, as new high-speed equipment is connected into optical networks, it is often desirable to multiplex lower speed equipment into the higher speed network for transport in order to take advantage of the transport capacity at the higher speed. Multiplexing slower data streams gives rise to certain problems.

For instance, in order to multiplex data streams from slower SONET or SDH format, the frames which make up the streams must be pointer processed and reformatted. The pointer processing of the prior art changes certain frame header information which changes how the frames appear after transmission. Transport service customers using the network often find changes to the frames unacceptable, preferring a “seamless” or “transparent” transport of SONET frames. In the art, “seamless” transport is known as “transparency”.

High speed optical networks must reproduce each frame exactly in order to maintain transparency. Along with frame header information, the overhead fields of frame based data streams often contain user and other proprietary channels that provide important services. Any operations that alter these fields can result in loss of user channels and services. Thus, transparency is the ability to transport data streams through a system without manipulating the overhead fields.

Transparency is easier to maintain with a single data stream. If a single data stream is sent across a transport system, the transparency is maintained using “through timing”. “Through timing” disables all processing circuits that alter the data stream so that all user services are available and unaltered. Transparency is harder to achieve when aggregating multiple plesiosynchronous data streams because there are multiple independent clock domains for each data stream that must be aggregated on to a single clock domain for transport.

In the prior art, aggregation of frame-based plesiosynchronous data streams is achieved by terminating incoming frames in order to slow and synchronize the local clock of the receiving computer. This is particularly true of SONET formats. However, terminating SONET frames results in modification of the overhead bytes in the frames and destroys transparency.

Other prior art SONET systems use “pseudo-transparent” techniques to prevent loss of services. “Pseudo-transparent” techniques involve re-writing some of the overhead bytes to some unused memory locations in the overhead fields prior to modifying the overhead bytes. The frames are then transported across the network. The receiving computer recovers the modified bytes and regenerates most of the original header. However, in many cases, memory is insufficient to preserve the entire header and overhead information is lost. “Pseudo-transparency” cannot guarantee continuity of user services.

In the past, transparency has been difficult to achieve with plesiosynchronous data streams because both the data and timing have to be reproduced. The data streams can have timing variation as much as +/−100 parts per million (+/−20 ppm for SONET/SDH) from their nominal frequency. The timing variation provides a large amount of data that must be stored in buffers. There are physical limits to the size of the buffers when used in data path devices such as field programmable gate arrays (FPGAs). When data is passing through FPGAs at high data rates (greater than 155 megabits per second), often data tends to overflow the buffers.

Several prior art inventions have attempted to maintain transparency with varying success.

U.S. Pat. No. 6,151,334 to Kim, et al., entitled SYSTEM AND METHOD FOR SENDING MULTIPLE DATA SIGNALS OVER A SERIAL LINK, discloses a method and system for sending multiple data signals over a serial link that uses an embedding unit to encode data streams and then merge the encoded data into a serial stream that is output across a serial line to a removing unit. The removing unit receives the serial steam of data, decodes the serial stream and separates the decoded serial stream into separate streams and reconstructing the input streams. The encoding and transmission are transparent, but are not SONET based nor plesiosynchronous. The invention of Kim only moves data in time with respect to a radio synchronization signal, but does not address problems with frame based data or aligning timing information.

United States Patent Publication No. 2002/0080809 to Nicholson, et al., entitled SYSTEM AND METHOD FOR MULTIPLEXING SYNCHRONOUS DIGITAL DATA STREAMS, discloses a method and system for multiplexing synchronous parallel digital data streams with different clock frequencies into a single data stream while preserving each data stream's timing integrity. Digital data inputs and separate corresponding clock inputs are coupled to corresponding first-in-first-out (FIFOs) buffering. Additionally, clock inputs are coupled to a clock multiplexer (MUX). Nicholson does not address problems arising from multiple plesiosynchronous data streams.

United States Patent Publication No. 2002/0075903 to Hind, entitled MULTIPLEXING SONET/SDH DATA STREAMS USING INDEPENDENT ENCODING SCHEMES, discloses a system and method for transparently multiplexing/demultiplexing synchronous data streams without pointer processing or protocol conversion. The system uses encoding schemes to enable recovery of the respective data streams from the aggregate data stream. However, in Hind the synchronous data streams must all have the same bit rate. Hind does not address or solve the problems arising from multiple plesiosynchronous data streams.

U.S. Pat. No. 6,396,853 to Humphrey et al., entitled PROVIDING DATA SERVICES TO TELECOMMUNICATIONS USER TERMINALS, discloses a method of multiplexing one or more plesiosynchronous packet data channels together with lower priority asynchronous traffic into a single composite data stream. The plesiosynchronous data packets each comprise a number of bytes together with a header element containing channel identification information and a packet length indicator. In Humphrey, et al., the frames are not transparent and, moreover, Humphrey does not address or solve the problems of transparent transportation of plesiosynchronous framing.

Therefore, a need exists for a system to aggregate frame oriented plesiosynchronous data streams on to one high speed optical path in order to achieve transparency and preserve user channels wherein the data and timing are produced identically across the network. It is, therefore, desirable to provide a method and apparatus that permits a plurality of low-speed data streams to be multiplexed onto a high-speed data channel without terminating line, section or path of the low-speed data streams.

### SUMMARY OF INVENTION

The invention provides an apparatus and method for transparently transporting four OC-48 signals over a network via a 10 Gbps optical transport link. Transparent aggregation of plesio-synchronous data stream maintains true transparency ensuring that the input and output data streams are identical in timing and content.

In the present invention, multiple plesiosynchronous data streams are aggregated onto an independent clock source at an ingress circuit through the use of “stuffing” bits. The independent clock is selected such that the output data rate is greater than the composite input data rate of all the plesiosynchronous data streams. The independent clock prevents buffer overflow and provides an opportunity to embed timing information into the data frames.

The resulting signal is encapsulated with forward error correction (FEC) at the transport interface, serialized, and modulated across the transport system. The FEC provides for correction of errors caused due to data impairments in the transport system.

An egress circuit at the receiving end recovers the modulated signal and inputs it into a FEC circuit that corrects errors in the transmission. The egress circuit extracts the data stream and timing information resulting in a return of the original data frames. The timing information is used to drive a voltage controlled oscillator which returns the plesiosynchronous timing of the original OC-48 signals. In this manner, the timing is reproduced identical to the timing of the incident signal at the ingress path, ensuring the data is identical in content and timing.

One advantage of the invention is transparent data communication over the transport system.

Another advantage is having two or more sets of signals aggregated into one optical fiber data stream. Without plesiosynchronous aggregation, the two or more set of signals would each have to be independently transported over the network and consume valuable bandwidth.

Another advantage is that the input signals do not require a common timing source. In other words, many different users can all use the same system without the need for clock synchronization.

Still another advantage of the current invention is that frame-based data in many variations can be transported transparently. Different users can transport different frame based data. Compatibility adds to the flexibility of the system and reduces overall cost to the user.

Yet another advantage is integrated error correction for each data stream. Instead of required error correction for each signal, only error correction for a combined signal is required. Overall system cost is reduced and efficiency is increased.

Still another advantage is bit level stuffing to accomplish precision timing. By stuffing individual bits into frame, relatively precise data rates can be obtained. This also increases system efficiency.

### BRIEF DESCRIPTION OF THE DRAWINGS

A better understanding of the invention can be obtained from the following detailed description of one exemplary embodiment is considered in conjunction with the following drawings in which:

FIG. 1 is a block diagram depicting a transport system according to the preferred embodiment of the present invention.

FIG. 2 is a block diagram depicting an ingress circuit according to the preferred embodiment of the present invention.

FIG. 3 is a block diagram depicting an ingress field programmable gate array according to the preferred embodiment of the present invention.

FIG. 4 is a flow chart depicting the find frame algorithm of the present invention.

FIG. 5 is a block diagram depicting an egress circuit according to the preferred embodiment of the present invention.

FIG. 6 is a block diagram depicting an egress field programmable gate array according to the preferred embodiment of the present invention.

FIG. 7 is a graph showing the number of stuffing bits added to each frame based on the deviation from a frame's clock and a faster line clock according to the nominal process of the preferred embodiment of the present invention.

FIG. 8 is a block diagram depicting a forward error correction system according to the ingress block of the preferred embodiment of the present invention.

FIG. 9 is a block diagram depicting a pipelined barrel roller according to the preferred embodiment of the present invention.

FIG. 10 is a block diagram depicting a forward error correction system according to the egress block of the preferred embodiment of the invention.

### DETAILED DESCRIPTION OF THE PREFERRED EMBODIMENT

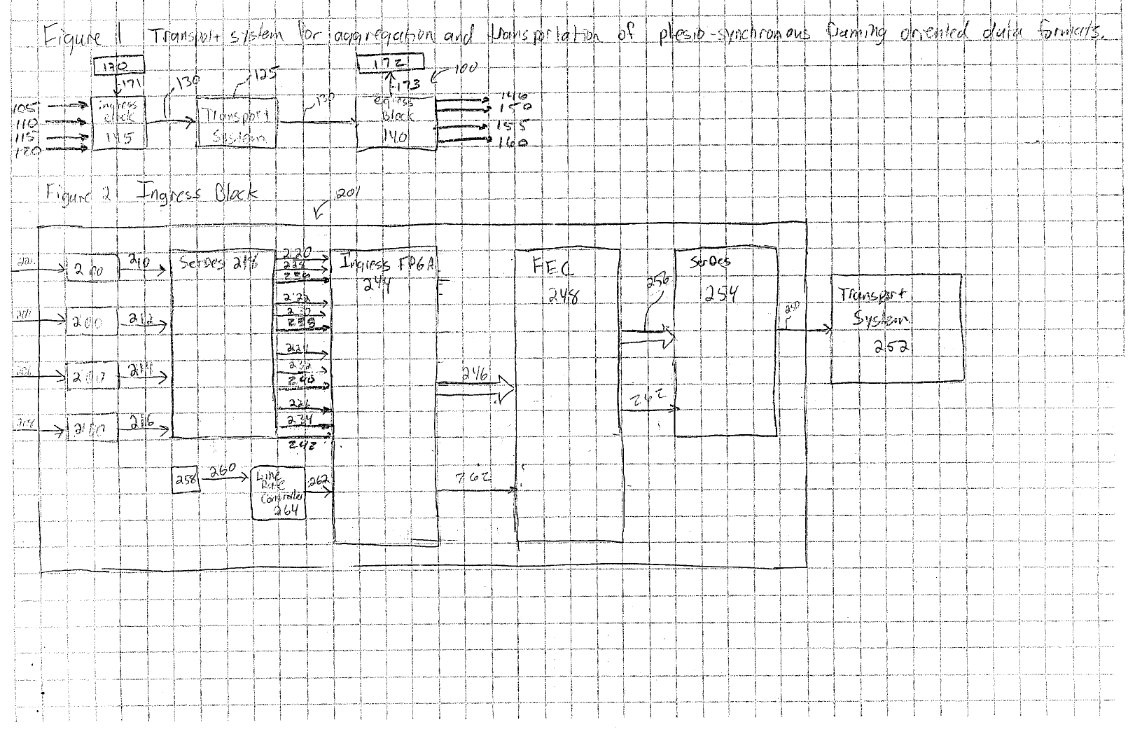

FIG. 1 shows a block diagram of the transport system for aggregation and transportation of plesiosynchronous framing oriented data formats 100. System 100 is a full duplex transport system, the circuits used for aggregation and recovery at both ends of the network are mirror images.

In the preferred embodiment, four plesiosynchronous OC-48 data streams 105, 110, 115, and 120 are aggregated by ingress block 145 and transported across transport system 125 in a composite stream 130. Greater or fewer OC-48 streams may be accommodated in alternate embodiments by scaling the disclosed components. At ingress block 145, there is a timing uncertainty of approximately +/−20 parts per million (ppm) from the received nominal OC-48 frequency of 2.488 Gbps from each data stream. The timing uncertainty is tracked and corrected in the ingress block 145. Preferably, composite stream 130 has a fast line clock rate approximately 400 ppm faster than the combined input data rate of plesiosynchronous OC-48 data streams. The fast line clock rate prevents buffer overflow and ensures there are bit stuffing opportunities between frames to embed timing information. In order to increase the clock rate for the plesiosynchronous OC-48 data streams to a 400 ppm faster line clock rate, data bits are added or “stuffed” into each frame in each OC-48 stream in the ingress block 145. The result is that composite stream 130 contains 16 data bits plus 1 clock bit per clock cycle.

Composite stream 130 is transported across transport system 125 to egress block 140. Egress block 140 removes the stuffed data from composite stream 130 and determines the clock rate of each OC-48 data stream. A voltage controlled oscillator 628 (described in detail in reference to FIG. 6) in egress block 140 is implemented to reconstruct the plesiosynchronous nature of the clock rate for each data stream. The recovered clocks are used to output individual plesiosynchronous OC-48 data streams 146, 150, 155, and 160 which contain the same data and clock information as plesiosynchronous OC-48 data streams 105, 110, 115, and 120. Thereby multiple plesiosynchronous data streams are transparently transported over transport system 125.

Processor 170 connected to ingress block 170 can add user data to a stuffing word through line 171. The user data is read by downstream processor 172 through line 173 connected to egress block 140.

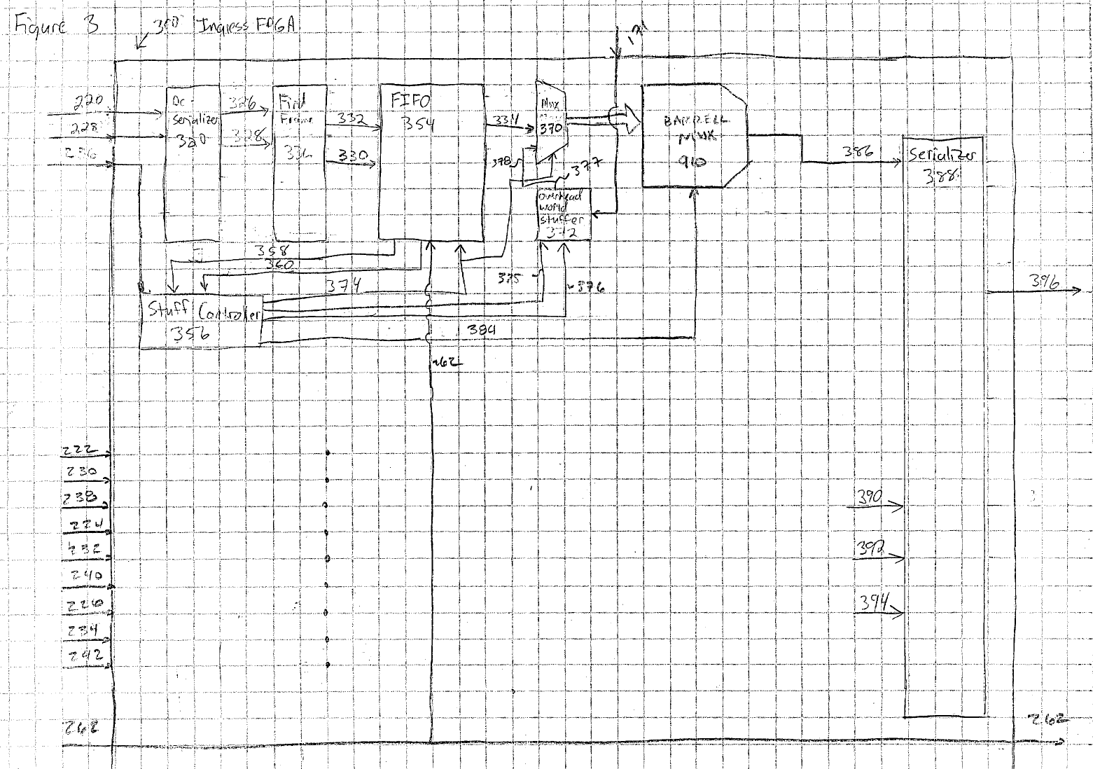

Referring to FIG. 2, a block diagram of the preferred embodiment of ingress block 145 is shown in greater detail. Ingress block 145 is shown in FIG. 2 as ingress block 201. The ingress path consists of four optical transceivers 200, each capable of receiving a single plesiosynchronous OC-48 data stream 202, 204, 206, and 208. In the preferred embodiment, each optical transceiver 200 is a small form-factor pluggable (SFP) optical transceiver. The four OC-48 data streams are converted into electrical output signals 210, 212, 214, and 216 by optical transceivers 200. Electrical output signals 210, 212, 214, and 216 are transmitted to Serializer/Deserializer (SerDes) 218. SerDes 218 receives electrical output signals 210, 212, 214, and 216 and from electrical output signal 210 generates recovered OC-48 clock signal 220, data signal 228, and frame sync pulse 236, from electrical output signal 212 generates recovered OC-48 clock signal 222, data signal 230, and frame sync pulse 238, from electrical output signal 214 generates recovered OC-48 clock signal 224, data signal 232, and frame sync pulse 240, and from electrical output signal 216 generates recovered OC-48 clock signal 226, data signal 234, and frame sync pulse 242. The four recovered OC-48 clock signals 220, 222, 224, and 226 are 311 MHz signals. The four data signals 228, 230, 232, and 234 are 4 bit wide ×622 MHz signals. The four frame sync pulses 236, 238, 240, and 242 indicate the start of a frame for each data stream.

System clock 258 is a system wide clock. System clock 258 transmits a slow system clock rate signal 260 to line rate controller 264. For OC-48 frame conversion in the preferred embodiment, clock rate signal 260 is 622.08 MHz. Line rate controller 264 converts the slow system clock rate signal 260 to faster line clock rate signal 262. Faster line clock rate signal 262 is calculated by the controller 264 as follows:

Faster line clock rate (Hz)=system clock rate (Hz)*N ppm (parts per million)/1,000,000+system clock rate (Hz).

Wherein N is an integer ranging from about 100 to about 700 ppm. In the preferred embodiment, N=400 ppm. At N=400 ppm, the line clock rate is 400 ppm faster than the system clock rate. For example, for OC-48 signals, the faster clock rate is 622.32 MHz. The upper limit of N is limited by the choice of the voltage control oscillator as in known in the art. Faster line clock rate signal 262 runs at a fixed factor above the system clock rate to allow for overhead bit stuffing and the maximum possible differences in the four OC-48 data stream clocks.

Recovered OC-48 clock signals 220, 222, 224, and 226, data signals 228, 230, 232, and 234, and frame sync pulses 236, 238, 240, and 242 are transmitted from SerDes 218 to ingress field programmable gate array (FPGA) 244 where data signals 228, 230, 232, and 234 are processed into composite signal 246 as discussed below. Faster clock rate signal 262 is also transmitted to FPGA 244. Composite signal 246 is comprised of 16×622 MHz parallel signals governed by the faster line clock rate signal 262. Composite signal 246 is received by ingress FEC 248 and processed into transport composite signal 256. Composite signal 256 contains 16 parallel FEC output signals at the faster line clock rate. As is known in the art, the FEC output signals contain both the data and the input clock encapsulated in the FEC code. When the receiving FEC performs error correction on the signal, both the data and clock are recovered by a method know in the art as “through timing”.

Transport composite signal 256 is transmitted to SerDes 254. SerDes 254 serializes transport composite signal 256 into composite stream 250 comprised of a single bit wide channel at the fast clock rate. SerDes 254 transmits composite stream 250 to transport system 252 for transmission.

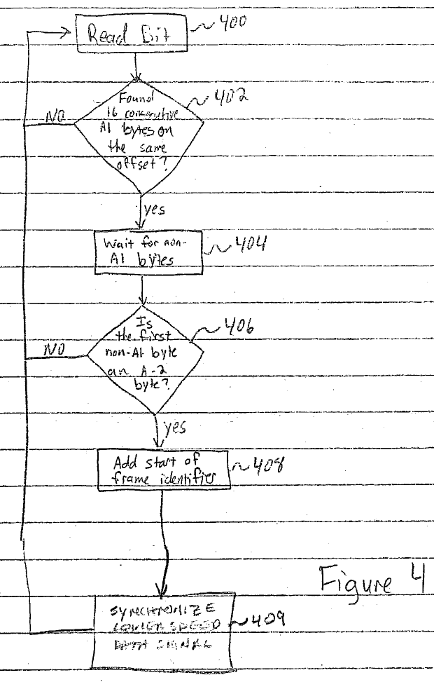

FIG. 3 is a block diagram showing a portion of the preferred embodiment of ingress FPGA 244 in greater detail. Ingress FPGA 244 is shown in FIG. 3 as ingress FPGA 300. Ingress FPGA 300 receives recovered OC-48 clock signals 220, 222, 224, and 226, data signals 228, 230, 232, and 234, and frame sync pulses 236, 238, 240, and 242 transmitted from SerDes 218 (FIG. 2). Frame sync pulse 236 is sent to stuff controller 356. OC-48 clock signal 220 and data signal 228 are sent to deserializer 320. In the preferred embodiment, data signal 228 is at a rate of 622 MHz by 4 bits wide. Deserializer 320 converts OC-48 clock signal 220 into a 155 MHz single OC-48 clock signal 326 and splits data signal 228 into 16×155 MHz lower speed data signal 328 with an I/O rate of 622 MHz. OC-48 clock signal 220 is at a rate of 311 MHz ddr (double data rate). Each OC-48 clock signal 220, 222, 224, and 226 is plesiosynchronous to the other OC-48 clock signals 220, 222, 224, and 226.

Signals 326 and 328 are transmitted to find frame circuit 336.

Find frame circuit 336 recognizes and declares frames. The SONET frame has a header that is represented by 48 A1 bytes followed by 48 A2 bytes. Stuffing rate adaptation and performance monitoring functions require the SONET frame to be synchronized to a common clock such as that of slow system clock rate signal 260. The input data from deserializer 238 is correctly ordered but is not frame or even bit aligned. Find frame circuit 336 recognizes a frame for lower speed data signal 328 and will declare a frame if 16 or more consecutive A1 bytes are followed by a single A2 byte.

FIG. 4 shows a flow chart of the algorithm used by find frame circuit 336 to declare a frame. To determine where each frame is, find frame circuit 336 reads all 16 possible bit offsets of the 16 bit wide 155 MHz signal in lower speed data signal 328 at step 400. For each 16 bit word read, find frame circuit 336 determines if there are 16 A1's in a row, step 402. Once find frame circuit 336 finds 16 A1 bytes in a row on any one offset, it looks for at least one A2 byte immediately following the end of all A1 bytes on that offset, steps 404 and 406. Once find frame circuit 336 finds an A2 byte, it locks in the offset as being in the correct bit alignment position, adds a start of frame identifier at step 408. After find frame circuit 336 assigns an identifier, it synchronizes lower speed data signal 328 to the rate of slow system clock signal 260 to produce synchronized lower speed data signal 332 at step 409. Synchronized lower speed data signal 332 is a 16×155 MHz signal. Find frame circuit 336 then returns to step 400 to begin searching for another frame.

Returning to FIG. 3, synchronized lower speed data signal 332 and start of frame identifier signal 330 are transmitted to first-in/first-out buffer (FIFO) 354. Preferably, FIFO 354 is a 511 deep by 17 bits wide dual port, dual clock domain FIFO. FIFO 354 outputs aligned fast data signal 334 to multiplexer (mux) 370. Aligned fast data signal 334 is synchronized to faster line clock rate signal 262 via clock input 262.

Stuff controller 356 coordinates the processes necessary to add data to frames and adjust timing of the ingress circuit. Stuff controller 356 calculates the number of words needed to adjust timing and transmits this number to word stuffer 372. It also calculates the necessary advancement of barrel mux 910 to “fine tune” the output signal.

There are two concurrent processes employed by stuff controller 356 to calculate the number of stuffing bits in the frames to match the faster line clock rate for each frame, the “FIFO depth” process and the “nominal bit” process. The FIFO depth process reduces wander but increases jitter. The nominal bit process increases wander but reduces jitter. Wander is long-term random variations of the significant instants of a digital signal from their ideal positions. Jitter is the deviation in or displacement of the signal caused by a shaky pulse.

Both processes are executed by the logic in stuff controller 356. In the preferred embodiment, both processes run at the same time. However, the nominal bit process is preferred and is used for all calculations unless the limits of the FIFO depth process are exceeded in an overflow condition. Examples of a FIFO overflow condition are on start-up of the system with erratic signals or receipt of partial frames. The nominal bit process is a more precise process and can operate inside a preferred range of the FIFO depth process without interference from the FIFO depth process. The FIFO depth process is only used as a back-up method when erratic system performance requires it.

The FIFO depth process uses the depth of FIFO 354 to control the clock rate. The FIFO 354 depth is checked once per frame. If the FIFO 354 depth is outside a certain range then a bit is added or subtracted from the current number of bits being added to each frame. For example, the range on the FIFO 354 depth is 8-503 and preferably is between 202-204. If the FIFO 354 depth is below the range, the number of bits being added to each frame is increased to increase the data rate. If the FIFO 354 depth is above the range, the number of bits being added to each frame is decreased to decrease the data rate. Stuffing bits are added or subtracted from a nominal or default bit stuff value of 76 bits (316-bit words +28 additional nominal stuffing bits) based on the incoming clock rate of aligned lower speed data signal 332 into FIFO 354.

To determine the number of bits needed to achieve the faster line clock rate, FIFO 354 transmits a frame synchronization signal 358 and a depth signal 360 to stuff controller 356. Depth signal 360 indicates how full FIFO 354 is. Frame synchronization signal 358 along with frame sync pulse 236 indicates how synchronized the frames are in relation to the faster line clock rate. Stuff controller 356 uses frame sync pulse 236, frame synchronization signal 358, and depth signal 360 to calculate the stuffing bits required to maintain the desired FIFO depth and minimize jitter impact on aligned lower speed data signal 332.

Stuff controller 356 calculates stuffing bits based on frame synchronization signal 358 and faster line clock rate 262. Aligned fast data signal 334 is transmitted from FIFO 354 to mux 370. Aligned fast data signal 334 is a 16×155 MHz signal. Stuff controller 356 monitors the depth of FIFO 354 to ensure the desired depth is maintained. If the FIFO 354 depth goes over a programmable maximum threshold, stuffing bits will be subtracted. If the FIFO depth goes under a programmable minimum threshold stuffing bits will be added. The preferable maximum threshold is 257 and the preferable minimum threshold is 255. Anything outside this range may increase jitter and time interval error.

In the nominal bit process, stuff controller 356, overhead word stuffer 372, and pipeline barrel roller mux 910, in concert, “stuff” three fixed 16-bit overhead words plus any additional stuff bits that may be required to the end of each frame in aligned fast data signal 334.

Stuff controller 356 calculates the number of words to be stuffed using the nominal bit process. The nominal bit process, uses a nominal bit value to obtain the faster line clock rate. The nominal bit value is used if there is zero deviation between the frame clock rate and the faster line clock rate. The nominal bit value is calculated using the following equations:

Nominal Bit Value=Total Number of Stuff Bits−SONET Bits−Fixed Bits

Where SONET Bits is the number of bits in a SONET OC-48 frame (311040 bits as defined by SONET specification). Fixed Bits is three 16-bit words or 48 bits.

Total number of “stuff bits” is calculated by the following equation:

Total Number of Bits in Stuffed Frame=((OC-48 Clock Freq*output clock ppm/1,000,000)+OC-48 Clock Freq)/OC-48 Clock Freq)*SONET Bits

Total Number of Stuffing Bits=SONET bits−Total Number of Bits in Stuffed Frame

Where OC-48 Clock rateFreq. is the clock rate frequency of an OC-48 SONET stream (622.080 MHz defined by SONET specification). Output Clock PPM is the desired PPM increase of the faster line clock rate over the OC-48 Clock Freq.

In the preferred embodiment, the Nominal Bit Value is 76.

If there is no deviation between the frame clock rate and the faster line clock rate the Nominal Bit Stuffing value is used to increase the clock rate of the frame. If there is a deviation between the frame clock rate and the faster line clock rate then stuffing bits are added based on that deviation. The number of stuffing bits added to each frame to compensate for the deviation between the frame clock rate and the faster line clock rate in the nominal bit process is calculated using the equation:

Actual Bit Stuffing=Nominal Bit Value+(Frame Clock PPM*Bits/PPM Slope)

Where the “Actual Bit Stuffing” value is equal to the total number of bits being added, the “Frame Clock PPM” value is equal to the ppm of the frame clock, and the “Bits/PPM Slope” value is 5/16 for the preferred embodiment.

The nominal number of bits added to the frames is usually 76. These 76 bits are broken up into 16 bit “fixed” words and 26 additional “padding” bits. The three words are generated by overhead word stuffer 372. The first fixed stuff word contains a channel Loss Of Signal (LOS) and reserved bits. In the preferred embodiment, the input LOS bit is communicated downstream to report or emulate LOS on the drop side of the system. The lower byte of this word includes the nominal bit value calculated previously. It is sent to the overhead word stuffer 372 via line 375 and it is communicated to a downstream destuffer the number of additional stuff bits that were added to the current frame in order to properly adapt slow system clock rate 260 to the faster line clock rate 262. The second fixed stuff word is the “stuff message word”. The “stuff message word” is set by overhead word stuffer 372 and is read/write accessible by processor 170 through line 171. User data is often the payload of the second message word. The stuff message word is used as a 16 bit per channel/frame real-time overhead channel. The third fixed stuff word is used only for padding. To achieve faster line clock rate, the word and bit stuffer add additional bits to increase or decrease the data rate and achieve faster line clock rate. In addition to the three fixed stuff words, 26 padding bits are typically added. However, up to 255 padding bits can be added into each frame.

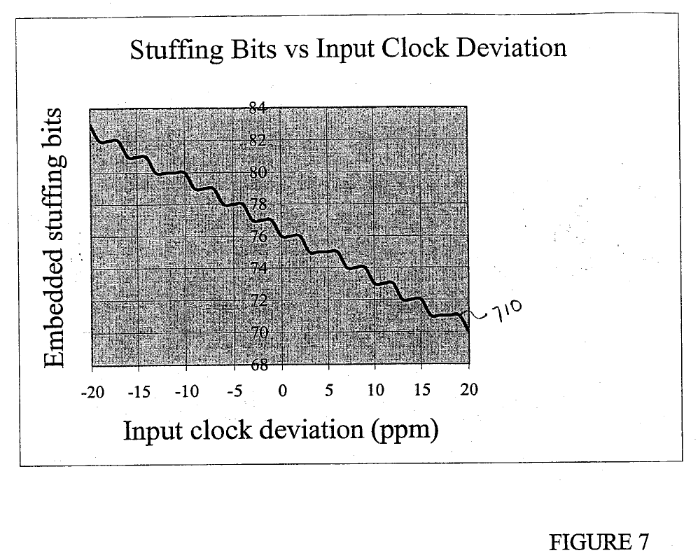

FIG. 7, is a graph showing the number of stuffing bits added to each frame based on the deviation from the frame's clock and the faster line clock. For example, consulting the “stuffing bits” curve 710, if the deviation of the frame's clock and the faster line clock is 15 ppm, then 72 stuffing bits will be added. If the deviation of the frame's clock and the faster line clock is −5 ppm, then 78 stuffing bits are added. “Stuffing bits” curve 710 is generated by a set of equations and constants and represents the stuffing bits to be added at a +400 ppm output clock. The equation is stored in stuff controller 356 for use by the nominal bit process. The average slope of curve 710 is 5/16 in the preferred embodiment.

Curve 710 is derived from the following set of constants and equations:

Inputs:

Input PPM (IPPM). SONET spec requires that −20 ppm to +20 ppm clock be tolerated.

Output PPM (OPPM). Delta for the line side clock.

Outputs:

Additional Stuffing Bits (ASB). Variable number of bits added to at the end of the sonet frame. This number excludes the 48 fixed stuffing bits.

CONSTANTS:

| | | |
|---|---|---|
| OC48FREQ | OC48 Optical Freq, Hertz = | 2488320000 |
| SFREQH | Serdes output to Ingress FPGA Freq, | 622080000 |
| | Hertz = | |
| SFREQM | SFREQH in MHz, MHz = | 622.08 |
| LFREQ | INGRESS to FEC line Freq, Hertz = | 622328832 |
| SFBITS | Standard bits in a SONET OC48 frame, | 311040 |
| | bits = | |
| FIXEDBITS | Fixed Stuffing Bits, bits = | 48 |
| BPW | Bits per word factor, bits/words = | 16 |

Formula:

The formula with intermediate variables:

Where n ranges from −20 to 20.

IPPM=n.

Desired stuffed frame size

DSFS(n)=((1/((SFREQM*IPPM)+SFREQH))*SFBITS)*LFREQ 1)

Actual Stuffing Bits with fraction

ASBF(n)=DSFS(n)−SFBITS−FIXEDBITS 2)

PPM bit Delta

PBD(n)=ASBF(n)−ASBF(n−1) 3)

Additional Words

AW(n)=INT((PBD(n)+0.5)/BPW); rounds AW to whole words. 4)

Fractional Additional Bits less Words

FABLW(n)=ASBF(n)−(AW(n)*BPW) 5)

Whole Bits

IF ROUND(FABLW(n))=BPW Then WB(n)=0

IF ROUND(FABLW(n)) not=BPW Then WB(n)=ROUND(FABLW(n)) 6)

Actual Stuffing Bits

ASB(n)=BPW*AW(n)+WB(n) 7)

If stuff controller 356 needs to add 16 or more bits to achieve faster line clock rate 262, then it will instruct overhead word stuffer 372 to add a word to aligned fast data signal 334. Using this method, stuff controller 356 can precisely control the data rate of stuffed signal 386 by adding 0-48 additional bits to each frame and allows the stuffing adjustments to be accurate to +/−1 bit at 2.5 GHz, or 400 ps while the logic is running at 155 MHz. Bits are stuffed after the last stuff word of the current frame and before the first A1 byte of the next frame.

To achieve faster line clock rate, stuff controller 356 sends a signal to FIFO 354 via FIFO control line 374 pausing the release frames to mux 370. The same signal is sent to the index of mux 370 switching it to admit the output of overhead word stuffer 372. Then, stuff control 356 sends a signal to overhead word stuffer 372 via stuff control word line 376 instructing overhead word stuffer 372 to add the necessary number of words to achieve the desired data rate through stuff line 377. Overhead word stuffer 372 generates and transmits the necessary number of words to mux 370 via a combined word signal 378.

In the preferred embodiment, mux 370 is a 2-to-116 bit mux. When it receives the necessary number of words from overhead word stuffer 372, it transmits 16 bit wide signal to pipeline barrel roller mux 910 for fine tuning.

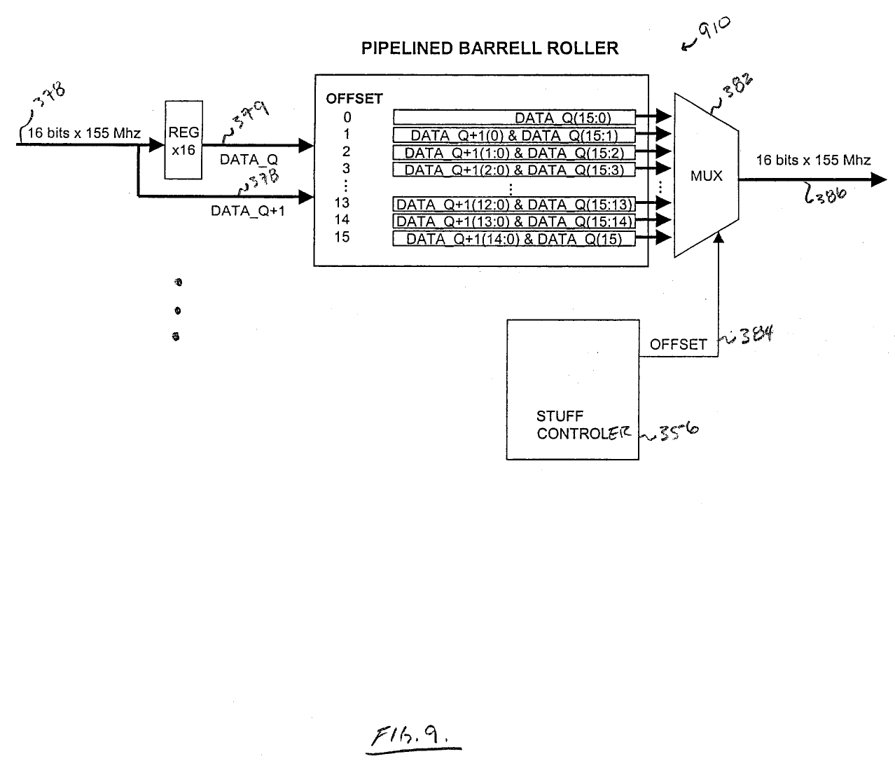

Pipeline barrel roller mux 910 is shown in FIG. 9. Pipeline barrel roller mux 910 is used to fine tune the number of bits in each frame to adjust timing. Pipeline barrel roller mux 910 adjusts the timing by 16 bits or less.

Combined word signal 378 enters pipeline barrel roller mux 910 and is 16 bits wide at 155 MHz. Signal 378 enters register 905 which is actually a register 16 bits wide as shown by the ellipsis. Signal 378 is also shunted to the input of pipeline barrel roller mux 910. Register 905 delays signal 378 by a single clock tick resulting in delayed signal 379. Pipeline barrel roller 910 allows the data from register 905 to be shifted in time by 0 to 16 bits according to an offset signal 384 from stuff controller 356. Once shifted, the data is released through mux 382. For example, if offset signal 384 is 0, mux 382 passes bits 15 through 0 of register 905 without shifting. If offset signal 384 is set to 1, the data is shifted 1 bit. Mux 382 then releases bits 15 through 1 from time 0, and bit 0 from time 1. If offset two is selected on line 384, data bits 15 through 2 will be passed from time 0 and data bits 1 and 0 will be passed from time t=1. If offset signal 384 is set to 3, data bits 15 through 3 will be passed from time 0 and data bits 2 through 0 will be passed from time t=1. Using pipelined barrel roller mux 382, stuff controller 356 can add up to 16 bits to each data frame.

Offset signal 384 is calculated by stuff controller 356 as follows for the ingress block:

tempvalue=OFFSET(n)+actual bit stuffing OFFSET(n) is the offset from the last frame.

Carry=INT(tempvalue/16)

Wherein OFFSET Carry is the number of words to be added to each frame. INT is a function generating a whole number.

OFFSET(n+1)=tempvalue−(16*Carry)

Wherein OFFSET(n+1) is the new position barrel roller mux is to be set in order to add 0-15 bits to the frame as described above. The OFFSET value is transmitted to barrel mux 910 via line 384.

WORDS=Carry+INT(actual bit stuffing/16)

where WORDS is the number of whole words to be stuffed into a frame. The WORDS value is transmitted to overhead word stuffer 372 via line 376.

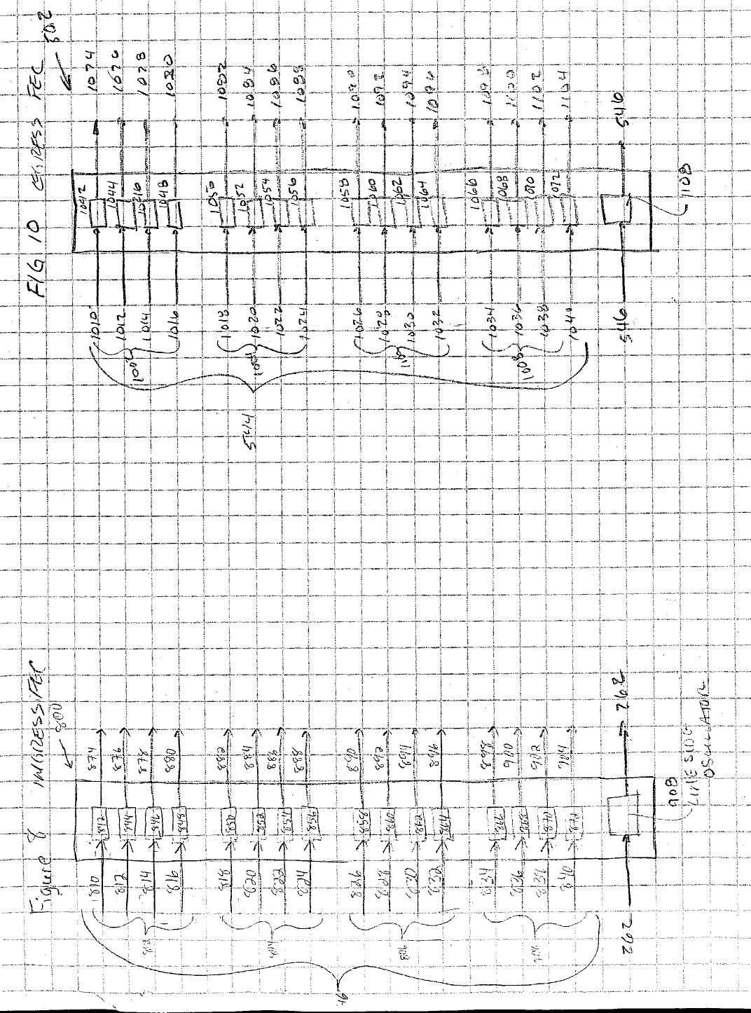

Returning to FIG. 3, stuffed signal 386 is a 16 bit×155 MHz signal and is transmitted from pipeline barrel roller mux 910 to serializer 388. Second group of signals 222, 230 and 238, third group of signals 224, 232 and 240, fourth group of signals 226, 234 and 242, proceed along an analogous path through a parallel and duplicative set of devices (as shown by the ellipsis) to achieve signals analogous to stuffed signal 386 produced from first group of signals. Second group of signals produce stuffed signal 390. Third group of signals produce stuffed signal 392. Fourth group of signals produce stuffed signal 394. Stuffed signal 386 and stuffed signals 390, 392 and 394 are transmitted to serializer 388. Serializer 388 serializes the 16×155 MHz stuffed signals 386, 390, 392, and 394 into four 4×622 MHz signals, creating a 16×622 MHz composite signal 396. By adding the precise number of stuffing bits to each frame, stuff controller 356 ensures that all of the frames and data streams are outputed at a common clock rate. Composite signal 396 emerges as composite signal 246 in FIG. 2 and is transmitted to FEC 248 as a 16×622.08 MHz signal. FEC 248 is shown in FIG. 8 as FEC 800 and its functions will be described with respect to FIG. 8. FEC 800 assigns each outputted data stream in composite signal 246 to one of four FEC lanes 802, 804, 806, and 808 for transport. FEC 800 has a 16-bit SFI-4 interface running at 622.08 MHz plus about 400 ppm higher clock rate to match the output of ingress FPGA 244. Ports 842-872 in FEC 800 act as 16 independent serial data ports. By assigning 4 FEC lanes 802, 804, 806, and 808 to OC-48 stream 246, any format data may be mapped to any combination of transport channels to achieve serial communications without embedding control codes for channel identification. FEC 800 encapsulates the data in composite signal 246 mapping it to signals 874-904 providing a 25% overhead error correction code, which provides greater than 9 dB of coding gain. FEC 800 receives signal 262 and passes it through line side oscillator 908 to be reproduced and transmitted to SerDes 254.

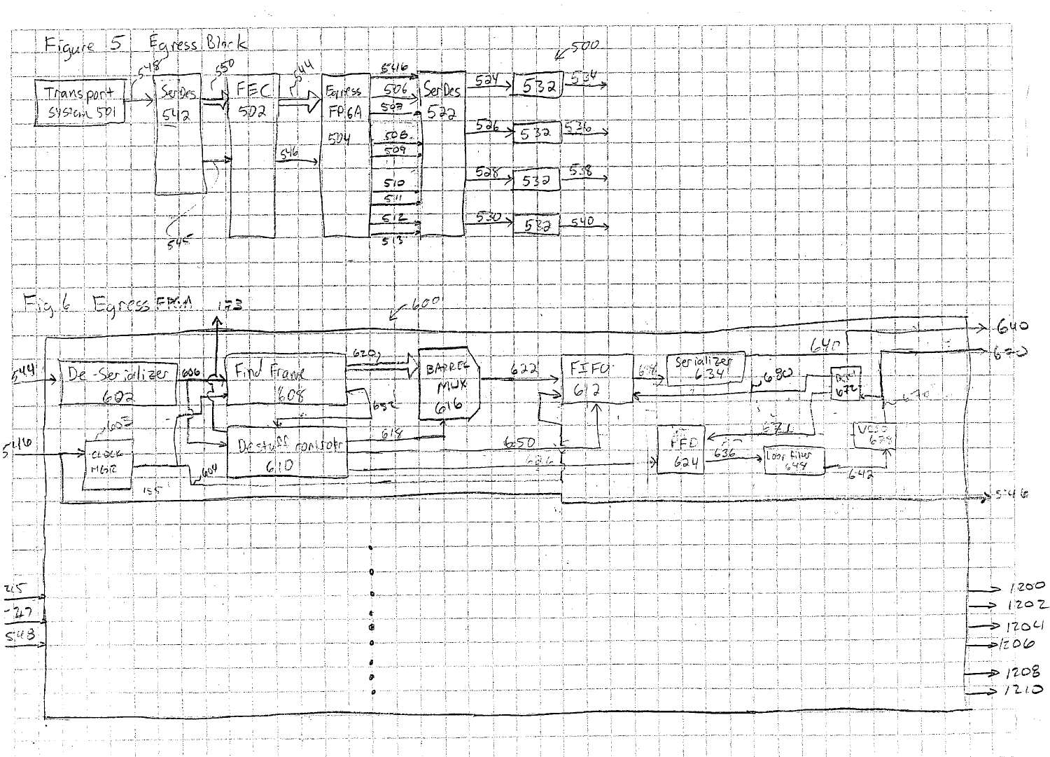

FIG. 5 is a block diagram of the preferred embodiment of egress block 140 shown in greater detail. Egress block 140 is shown in FIG. 5 as 500. Incoming signal is 548 is 1 bit wide 13.5 gigabit optical signal aggregated transport rate. SerDes 542 deserializes composite signal 548 into four FEC encoded channels, deserialized signal 550, at a clock rate of 777 MHz, and transmits deserialized signal 550 to FEC 502. SerDes 542 also recovers clock signal 545 which is at a rate of 777 MHz and transmits it to FEC 502. FEC 502 performs error correction on deserialized signal 550 and recovers composite data signal 544 and composite clock signal 546. Composite clock signal 546 is at the faster line clock rate of the ingress block, 622 MHz, and is 16 data bits wide. Composite data signal 544 and composite clock signal 546 are transmitted to egress FPGA 504 for data stream and timing extraction.

The structure and function of FEC 502 is shown and described in reference to FIG. 10. FEC 502 assigns each output of data stream in composite signal 550 to one of four FEC lanes, 1002, 1004, 1006 and 1008, for decoding. FEC 502 has a 16 bit SFI 4 interface running at 622.08 MHz +about 400 ppm higher clock rate to match the output of SerDes 542. Ports 1002 through 1008 in FEC 502 act as sixteen independent serial data ports. Thus, FEC 502 strips the error correction from the encapsulated data in composite signal 550, mapping it to signals 1074-1104, extracting the 25% overhead error correction code to obtain the 9 decibels of coding gain. FEC 502 receives clock signal 502, passes it through line side oscillator 1108 to be reproduced and transmitted to SerDes 522.

Egress FPGA 504 removes the stuffing bits from each frame, re-clocks the signal and transmits four plesiosynchronous OC-48 channels 506, 508, 510, and 512 to SerDes 522 as 4 bit wide 311 MHz data clocked signals at double data rate resulting in a clocked signal of 4×622.08 MHz. SerDes 522 serializes plesiosynchronous OC-48 channels 506, 508, 510, and 512 which are each 4×311 ddr signals, and transmits four plesiosynchronous OC-48 data streams 524, 526, 528, and 530 which are 1 bit wide 2.5 GHz signals containing the same data and timing as the four input plesiosynchronous OC-48 data streams 105, 110, 115, and 120 (FIG. 1) to SFP 532. SFP 532 converts the electrical plesiosynchronous OC-48 data streams 524-530 to optical outputted plesiosynchronous OC-48 data streams 534-540.

FIG. 6 is a block diagram showing the preferred embodiment of egress FPGA 504 in greater detail. FPGA 504 is shown in FIG. 6 as 600. Deserializer 602 deserializes composite signal 544 from a 4×622 MHz signal into a 16×155 MHz deserialized signal 606. Deserialized signal 606 is transmitted from deserializer 602 to find frame circuit 608 and destuff controller 610. Composite clock signal 546 runs at 622 MHz and is connected to global clock manager 603 where it is converted into a 155 MHz +400 ppm clock signal 604. Clock signal 604 is connected to find frame circuit 608, and the input side of FIFO 612.

Find frame circuit 608 recognizes and declares data frames for each stream in the same process as described with respect to find frame circuit 336. Find frame circuit 608 utilizes deserialized signal 606 and clock signal 604 to produce a frame aligned data signal 620 that is 16 bits wide at 155 MHz +400 ppm and a frame identifier signal 632. Frame identifier signal 632 is transmitted to destuff controller 610.

Destuff controller 610 uses frame identifier signal 632 to identify the start of a frame in deserialized signal 606 and to recover the embedded timing information from deserialized signal 606. Destuff controller 610 also extracts the user data from the second stuffing word and transmits it to processor 172 (FIG. 1) through line 173. The timing information is embedded by stuff controller 356 (FIG. 3) in the first stuffed word at the start of each frame.

Part of the embedded timing information includes the additional number of bits and the amount of fixed stuffing bits added to each frame. Once the total number of bits added to each frame is determined, destuff controller 610 uses the following formulas to calculate the number of stuffing words and stuffing bits to be removed from each frame.

Total Stuffing Bits=Additional Bit Stuffing+Fixed Stuffing Bits

Wherein Additional Bit Stuffing =the number of additional bits stuffed into the SONET frame during the Ingress stuffing process. Fixed Stuffing Bits=48 as explained above. Both values are part of the first stuffing word

tempINT=INT(Total Stuffing Bits/16)

tempREM=TSB−(tempINT*16)

If tempREM>Offset(n) then Carry=1 otherwise Carry=0;

Words=Carry+tempINT

The value of “Words” is equal to the number of whole words that the destuff controller 610 will extract from the data path. The calculated number of words is sent to FIFO 612 as extracting word signal 650.

Offset(n+1)=(Carry*16)+Offset(n)−tempREM

Wherein Offset(n) is equal to the offset of pipeline barrel roller mux 616. Offset(n+1) is equal to the next barrel roller offset. The offset calculated is sent to pipeline barrel roller mux 616 as an extracting signal 618.

Pipeline barrel roller mux 616 is of the same structure as barrel mux 582 shown in FIG. 9. A similar set of registers, mux and signals are included with similar functions and a description will not be repeated.

After the number of stuffing words and stuffing bits added to each frame by the ingress block is calculated from the first fixed stuff word by destuff controller 610, destuff controller 610 transmits extracting bit signal 618 to pipeline barrel roller mux 616 to extract the stuffing bits from each frame. Extracting bit signal 618 effectively “rolls back” the pipelined barrel roller mux 616 and removes the stuffing bits. Destuffed signal 622 is transmitted from pipelined barrel roller mux 616 to egress FIFO 612. Egress FIFO 612 is a 511 deep by 16 bits wide dual port, dual clock domain FIFO buffer. The input side of egress FIFO 612 receives destuffed signal 622 from pipelined barrel roller mux 616. Destuffed signal 622 is a 16 bit signal synchronized to faster line clock rate. Destuffed signal 622 has had all stuffing bits removed but has not had the stuffing words removed. Destuff controller 610 transmits extracting word signal 650 to egress FIFO 612 to effectively extract the stuffing words from each frame. At the end of each frame, destuff control 610 will disable egress FIFO 612 for a calculated number of clock cycles to effectively extract all of the remaining stuffing words.

Egress FIFO 612 transmits output signal 638 to serializer 634. Output signal 638 is a 16×155 MHz signal and is at the slower system clock rate because all of the stuffing words and bits have been removed. Serializer 634 is a 4 to 1 serializer and converts output signal 638 to a 4×622 MHz serialized OC-48 channel 640. Channel 640 is sent to SerDes 522 (FIG. 5) and is analogous to signal 506.

Original OC-48 clock signal 670 for the 4×622 MHz serialized OC-48 signal 640 is generated by VCSO 628.

Destuff controller 610 generates timing signal 626 as a data rate reference for PFD 624. The data rate reference clock is the clock rate of the original inputted OC-48 signal and is derived as follows:

| | |
|---|---|
| Frame Factor = | (311040)/(311040 + actual bit stuffing + 48) |
| Data rate reference = | faster line clock rate/302 * Frame Factor |
| System Clock reference = | faster line clock rate/302. |

Where 311040 is the number of bits in an OC-48 frame. The value of “Actual bit stuffing” is the total number of bits added to the frame. The value of “Data rate reference” is the clock rate of the original inputted OC-48 signal.

Destuff controller 610 transmits the data rate reference to PFD 624 via timing signal 626. PFD 624 also receives a clock signal 671 from DCM 672. Clock signal 671 is a 576 Khz clock signal. A frequency of 576 KHz is chosen because the frequency is outside the preferred range of loop filter 648, discussed below, and low enough to be within the optimal operating range of most commercially available PFDs 624. Based on the phase difference between timing signal 626 and clock signal 671, PFD 624 generates phase error signal 636. Phase error signal 636 is a pulse-width modulated (PWM) signal proportional to the phase difference between clock signal 671 and timing signal 626. Phase error signal 636 is created by taking the phase of signal 671 and subtracting the phase of timing signal 626, then multiplying the result by the constant Kp, wherein Kp is a standard known constant of 0.525 volts/radian. This converts the phase difference between the two signals into an AC voltage phase error signal 636. PFD 624 transmits phase error signal 636 to loop filter 648.

Loop filter 648 is an op amp circuit with a set bandwith. The bandwidth is in the range of 200 Hz-10 Khz and preferably around 500 Hz to reduce jitter on VCSO 628. If the bandwidth of the loop filter 648 is too high (beyond 10 kHz), it increases the frequencies allowed to pass into VCSO 628. When all the frequencies are allowed to pass into VCSO 628, more noise is created resulting in increased jitter at the VCSO 628 output. If the bandwidth is too low, it may not allow the frequency content of the error signal 636 generated from PFD 624 to pass through to the VCSO 628. Loop filter 648 recieves error signal 636 and converts the AC error signal 636 into filtered DC voltage signal 642. Filtered DC voltage signal 642 is transmitted to VCSO 628.

Filtered DC voltage signal 642 drives VCSO 628 to produce OC-48 clock signal 670. OC-48 clock signal 670 is a 311.04 MHz ddr signal at +−20 ppm which is equivalent to the input frequency of the original OC-48 clock signal 220 (FIG. 2). OC-48 clock signal 670 is transmitted to DCM 672. DCM 672 receives the 311.04 MHz ddr OC-48 clock signal 670 and divides to produce 576 Khz clock signal 671 which, in turn, is sent to PFD 624.

OC-48 clock signal 670 is also transmitted to SerDes 522 and is analogous to signal 507 (FIG. 5).

DCM 672 generates adjustment signal 680 and transmits it to FIFO 612.

Adjustment signal 680 is a 155.52 MSE clock signal and is used by FIFO 612 to make fine adjustments to the OC-48 frames to restore their original plesiosynchronous timing.

The structure and function of components described with respect to signal 544 are duplicated for signals 545, 547, and 548 resulting in signals 1200-1210 which are sent to SerDes 522 as shown by the ellipsis. Signals 1200-1210 are analogous to signals 508-513.

Referring again to FIG. 5, egress FPGA 504 outputs 4 plesiosynchronous OC-48 channels 506, 508, 510, and 512 to SerDes 522. OC-48 channels 506, 508, 510, and 512 are transmitted to SerDes 522 as 4 bit wide 311 MHz data clocked signals at ddr.

SerDes 522 serializes OC-48 channels 506, 508, 510, and 512 and transmits four plesiosynchronous OC-48 data streams 524-530 that have the exact same data and timing as the inputted four plesiosynchronous OC-48 data streams 105, 110, 115, and 120 (FIG. 1) to SFP 532. SFP 532 converts the electrical plesiosynchronous OC-48 data streams 524, 526, 528, and 530 to optical outputted plesiosynchronous OC-48 data streams 534, 536, 538, and 540.

Although the invention has been described with reference to one or more preferred embodiments, this description is not to be construed in a limiting sense. For example the method and apparatus can be used to aggregate and transparently transport a variety of formats and is not limited to OC-48 formats. There is modification of the disclosed embodiments, as well as alternative embodiments of this invention, which will be apparent to persons of ordinary skill in the art, and the invention shall be viewed as limited only by reference to the following claims.

1. A method for mapping a frame based data stream to independent lanes of a parallel reciprocal transport interface, the method comprising:
receiving a frame based data stream;
reading a system clock rate;
recovering a data signal from each data stream;
finding a frame in the recovered data signal;
aligning the frame to the system clock rate;
synchronizing the frame to a line clock rate higher than the system clock rate; and
mapping the frame to independent lanes of a parallel reciprocal transport interface.

2. The method of claim 1 wherein the received frame based data stream is plesiosynchronous with other frame based data streams.

3. The method of claim 1 wherein a frame sync pulse is recovered from the data stream and the recovered frame sync pulse is used to determine the start of a frame.

4. The method of claim 3 wherein the frame in the recovered data signal is found by first locating 16 consecutive A1 bits and at least one A2 bit after the first 16 consecutive A1 bits.

5. The method of claim 1 wherein the frame is synchronized to the line clock rate higher than the system clock rate by the addition of stuffing bits.

6. The method of claim 4 wherein the amount of stuffing bits added is at least three 16-bit overhead words.

7. The method of claim 9 wherein the first 16-bit overhead word contains a channel loss of signal and reserved bits.

8. The method of claim 9 wherein the second 16-bit overhead word contains a 16 bit per frame real-time overhead channel.

9. The method of claim 9 wherein additional bits are added to the at least three 16-bit overhead words to achieve the line clock rate.

10. The method of claim 12 wherein the number of bits added in addition to the at least three 16-bit words is 0-15 bits.

11. The method of claim 13 wherein a clock signal is recovered from each data stream.

12. The method of claim 14 wherein the number of bits added is used to indicate the deviation of the recovered clock from the line clock.

13. The method of claim 4 wherein the number of bits added is from 0-84.

14. A method for using the reciprocity of a FEC device to map independent channels, the method comprising:
serializing a first 16×155 MHz signal into a first 4×622 MHz signal having 16 bits;
transmitting the first 4×622 MHz signal to a forward error correction device wherein the forward error correction device has a 16-bit interface;
assigning four forward error correction channels to the first 4×622 MHz signal such the first 4 bits, bits 0-3, are assigned to channel 1, the next 4 bits, bits 4-7, are assigned to channel 2, the next 4 bits, bits 8-12, are assigned to channel 3, and the next 4 bits, bits 13-16, are assigned to channel 4;
serializing the four forward error correction channels into a single channel;
transmitting the single channel across a transport system;
receiving the transmitted single channel;
deserializing the single transmitted channel into a second 4×622 MHz signal;
transmitting the second 4×622 MHz signal to a receiving forward error correction device wherein the forward error correction device has a 16-bit interface;
assigning four forward error correction channels to the second 4×622 MHz signal such the first 4 bits, bits 0-3, are assigned to channel 1, the next 4 bits, bits 4-7, are assigned to channel 2, the next 4 bits, bits 8-12, are assigned to channel 3, and the next 4 bits, bits 13-16, are assigned to channel 4;
performing error correction on each channel in the second 4×622 MHz signal; and
deserializing the second 4×622 MHz signal into a second 16×155 MHz signal having 16 bits wherein the 16 bits of the second 16×155 MHz signal correspond to the 16 bits of the first 16×155 MHz signal.

15. A method for preventing buffer overflow and embedding timing information, the method comprising:
receiving into a buffer a first data stream having frames and a first clock;
aligning the frames;
adding timing information to each frame based on the first clock; and
increasing the first clock to a higher second clock by adding stuffing bits to the data stream wherein the increase is an amount that prevents buffer overflow and provides an opportunity to embed timing information.

16. The method of claim 18 wherein the increase from the first clock to the pre-selected clock is at least 100 ppm.

17. The method of claim 18 wherein the increase from the first clock to the pre-selected clock is 400 ppm.

18. The method of claim 18 wherein the amount of stuffing bits added is at least three 16-bit overhead words.

19. The method of claim 21 wherein the first 16-bit overhead word contains a channel loss of signal and reserved bits.

20. The method of claim 21 wherein the second 16-bit overhead word contains a 16 bit per frame real-time overhead channel.

20. The method of claim 21 wherein additional bits are added to the at least three 16-bit overhead words to achieve the line clock rate.

21. The method of claim 24 wherein the number of bits added in addition to the at least two 16-bit overhead words is 0-15 bits.

22. The method of claim 18 wherein the number of stuffing bits added is from 0-84.

23. A method for detecting frame boundaries and embedding stuffing bits between frames, the method comprising:
receiving a 16×155 MHz signal;
checking each bit in the 16×155 MHz signal for 16 A1 bits in a row;
conditioned upon finding 16 A1 bits in a row;
conditioned upon finding at least one A2 bit after the 16 A1 bits in a row; and
declaring a frame.

24. The method of claim 23 wherein a frame identifier is transmitted after declaring the frame.

25. The method of claim 23 wherein stuffing bits are embedding between the frames to increase the data rate.

26. The method of claim 23 wherein stuffing bits are embedding between the frames to decrease the data rate.

27. The method of claim 23 wherein timing information is embedding between the frames.

28. A method for removal of stuffing bits, the method comprising:
receiving a signal containing a number of added stuffing bits;
extracting the number of added stuffed bits from the signal;
transmitting the received signal to a first in first out element;
calculating the number of clock cycles to disable the first in first out element; and
disabling the first in first out element the calculated number of clock cycles thereby extracting the stuffing bits.

29. Using PFD to build a tracking filter that recovers the clock of each plesiosynchronous data stream after proprietary stuffing bits are removed.
